(19) United States
(12) Patent Application Publication
(10) Pub. No.: US 2013/0273221 A1
(43) Pub. Date: Oct. 17, 2013

(54) METHOD AND APPARATUS FOR BAKING FOOD PRODUCTS

(71) Applicant: Global Concepts Limited, Inc., dba Global TV Concepts, Ltd., Deerfield Beach, FL (US)

(72) Inventor: Laurie Braden, Deerfield Beach, FL (US)

(21) Appl. No.: 13/912,813

(22) Filed: Jun. 7, 2013

Related U.S. Application Data
(62) Division of application No. 13/271,663, filed on Oct. 12, 2011.
(60) Provisional application No. 61/498,109, filed on Jun. 17, 2011.

(51) Int. Cl. A21B 3/13

(52) U.S. Cl. CPC A21B 3/13
USPC 426/302; 426/512; 426/383

(57) ABSTRACT

The present disclosure relates generally to a method and apparatus for baking a food product. The method includes filling a plurality of filling a plurality of molds of a first piece of the baking apparatus with the food product, positioning a second piece of the baking apparatus over the first piece, engaging an alignment mechanism of the first piece and the second piece, heating the baking apparatus for a predetermined period of time, and removing the baking apparatus from heat.

### TECHNICAL FIELD

The subject matter of this application relates to methods and apparatus for baking. In particular, the subject matter of this application relates to methods and apparatus for baking food products such that the food products are molded into a predefined shape.

### BACKGROUND

Baking pans currently allow placement of an item to be baked on a surface for insertion into an oven, for example. Baking pans also allow for the ability to fill a mold in the baking pan with a food product to be baked. However, there is currently no means of forming a food product into a defined shape beyond the mold of a baking pan which is filled with the food product.

### SUMMARY

The present disclosure relates generally to an apparatus for baking a food product. The apparatus comprises a first piece and a second piece, the first piece and the second piece each comprise at least one mold which receives and shapes the food product. The apparatus further comprises an alignment mechanism which aligns and fastens the first piece and the second piece together.

In an additional embodiment, an apparatus for baking a food product is provided. The apparatus comprises a first piece and a second piece. The first piece comprises at least one mold, which receives and shapes the food product, and at least one opening formed in a first surface of the first piece. The second piece comprises at least one mold, which receives and shapes the food product, and at least one peg protruding from a second surface of the second piece. The at least one peg aligns with at least one opening of the first piece to attach the first piece to the second piece.

In yet another embodiment, a method for preparing a food product with a baking apparatus is provided. The method comprises filing a plurality of molds of a first piece of the baking apparatus with the food product. The method further includes positioning a second piece of the baking apparatus over the first piece. The second piece comprises a plurality of molds each comprising a hole. In addition, the method includes engaging an alignment mechanism of the first piece and the second piece and boating the baking apparatus for a predetermined period of time. Further, the method includes removing the baking apparatus from heat.

In yet another embodiment, a method for preparing a food product with a baking apparatus is provided. The method includes filling a plurality of molds of a first piece of the baking apparatus with the food product. The method further includes positioning a second piece of the baking apparatus over the first piece. The second piece comprises a plurality of molds corresponding to the plurality of molds of the first piece. The method further includes engaging an alignment mechanism such that the plurality of molds of the first and second pieces are in alignment. Further, the method includes heating the baking apparatus for a predetermined period of time at a predetermined temperature. Also, the method includes cooling the baking apparatus and removing the food product from the baking apparatus.

### BRIEF DESCRIPTION OF THE DRAWINGS

The forgoing summary and the following detailed description are better understood when read in conjunction with the appended drawings. Representative examples are shown in the drawings. However, it is understood that the examples are not limited to the specific methods and instrumentalities depicted herein. In the drawings:

FIG. 1 illustrates an embodiment of a baking apparatus comprising a first piece and a second piece.

FIG. 2 illustrates an embodiment of a baking apparatus comprising a first piece and a second piece viewed at an angle.

FIG. 3 illustrates another embodiment of a baking apparatus comprising a first piece and a second piece viewed at an angle.

FIG. 4A illustrates a cross-sectional view of an embodiment of an alignment mechanism.

FIG. 4B illustrates a cross-sectional view of an opening piece of an embodiment of alignment mechanism.

FIG. 4C illustrates a cross-sectional view of a peg portion of an embodiment of the alignment mechanism.

FIG. 5 illustrates an embodiment of a first piece of an embodiment of a baking apparatus when viewed from the top.

FIG. 6 illustrates an embodiment of a first piece of an embodiment of a baking apparatus when viewed from the bottom.

FIG. 7 illustrates an embodiment of a first piece of an embodiment of a baking apparatus when viewed at an angle.

FIG. 8 illustrates an embodiment of a view from a first side of a first piece of an embodiment of a baking apparatus.

FIG. 9 illustrates an embodiment of a view from a second side of a first piece of an embodiment of a baking apparatus.

FIG. 10 illustrates an embodiment of a second piece an embodiment of a baking apparatus when viewed from the top.

FIG. 11 illustrates an embodiment of a second piece of an embodiment of a baking apparatus when viewed from the bottom.

FIG. 12 illustrates an embodiment of a second piece of an embodiment of a baking apparatus when viewed at an angle.

FIG. 13 illustrates an embodiment of a view from a first side of a second piece of an embodiment of a baking apparatus.

FIG. 14 illustrates an embodiment of a view from a second side of a second piece of an embodiment of a baking apparatus.

FIG. 15 illustrates an example process for preparing a food product with a baking apparatus.

FIG. 16 illustrates an example process for preparing a food product with a baking apparatus.

FIG. 17 illustrates an example process for preparing a food product with a baking apparatus.

### DETAILED DESCRIPTION

It will be appreciated that the following description is intended to refer to specific examples of structure selected for illustration in the drawings and is not intended to define or limit the disclosure, other than in the appended claims.

The present disclosure provides apparatuses and methods for baking products, such as a food product. Notably, the apparatuses and methods produce a food product with a predetermined three-dimensional shape.

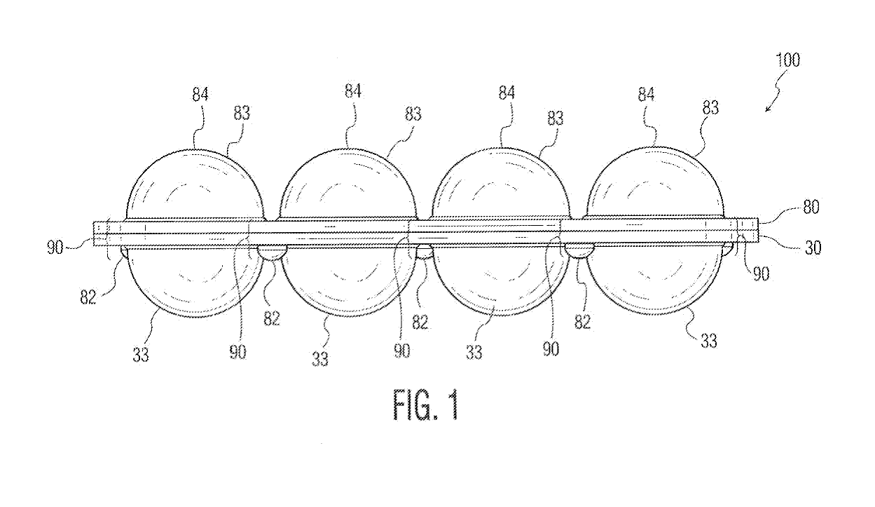

FIG. 1 provides a baking apparatus 100 comprising a first piece 30 and a second piece 80. The first piece 30 contains one or more indentions, such as molds 33, for example. The molds 33 may be shaped into a cup or hollow half of a sphere, for example. The molds 33 may also be molded into additional shapes which are able to hold matter, such as a food product. The food product may be cake batter or brownie batter, for example. The second piece 80 also contains one or more indentions, such as molds 83, for example. The molds 83 may be shaped into as cup or hollow half of a sphere, for example, or any other desired shape. Each mold 83 of the second piece 80 comprises a hole 84 for allowing air to escape during a heating process, for example. Although the baking apparatus 100 is shown with either the first piece 30 and the second piece 80 having eight or twelve molds 33, 83 in the present application, the first piece 30 and the second piece 80 may have more or less molds 33, 83 than depicted in the figures.

The first piece 30 and the second piece 80 are attached together through at least one alignment mechanism 90, such that the molds 33,83 of the first piece and the second piece 80 are in alignment, as illustrated in FIG. 1. The alignment mechanism 90 may be one or more openings 32 in a surface of the first piece 30 and one or more projections, such as pegs 82, which extend from a surface of the second piece 80, or vice versa. As should be understood, although not shown, any other suitable alignment mechanism other than openings 32 and pegs 82 may also be utilized where desired. The alignment mechanism 90 may be positioned around the edge of the first piece 30 and the second piece 80. In addition, an alignment mechanism 90 may also be placed in the middle of the first piece 30 and second piece 80, for example. The number of alignment mechanisms 90 may be more or less than the number shown in FIG. 1, and may also be positioned at other locations where desired. For example, the pegs 82 may be provided on the first piece 30, the openings 32 may be provided on the second piece 82, or various combinations of pegs 82 and openings 32 may be provided on both the first and second pieces 80 and 82, or in other components than that illustrated in FIG. 1.

The first piece 30 and the second piece 80 may be constructed from any material that is suitable for baking, such as at temperatures as high as 450 degrees Fahrenheit, as an example. For instance, the first piece 30 and second piece 80 may he constructed from a plastic, such as silicone, or metal, such as aluminum, although it should be understood that other suitable materials may be also be used. The first piece 30 and the second piece 80 may be placed together so that the inside of the molds 33 and 83 face each other and are substantially in alignment, as shown in FIGS. 1, 2, 3.

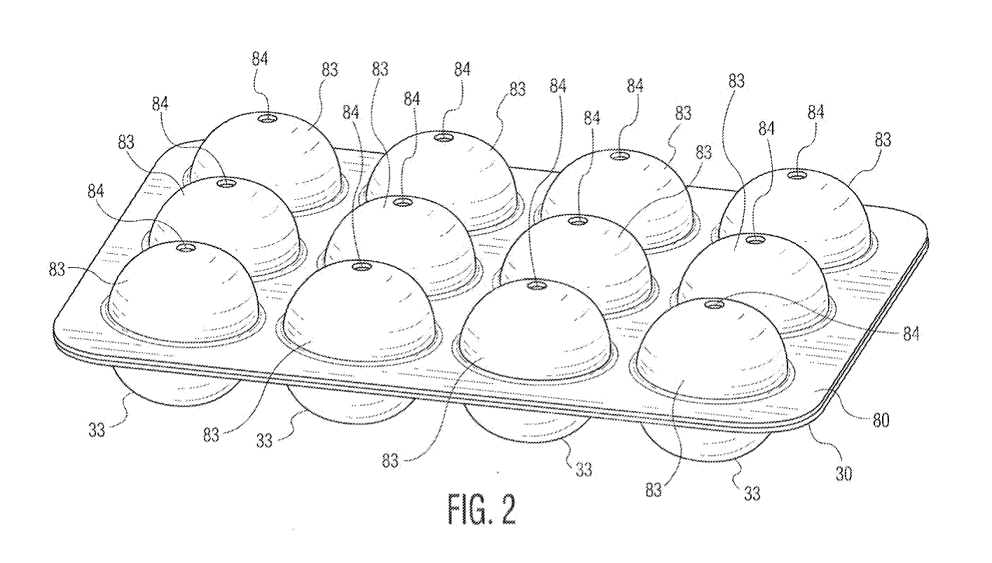

FIG. 2 illustrates the baking apparatus 100 of FIG. 1 as viewed from an angle. The baking apparatus 100 has a first piece 30 and second piece 80, each with twelve molds 33, 83 and in a 4×3 configuration, and with molds 83 also each having a hole 84 formed therein.

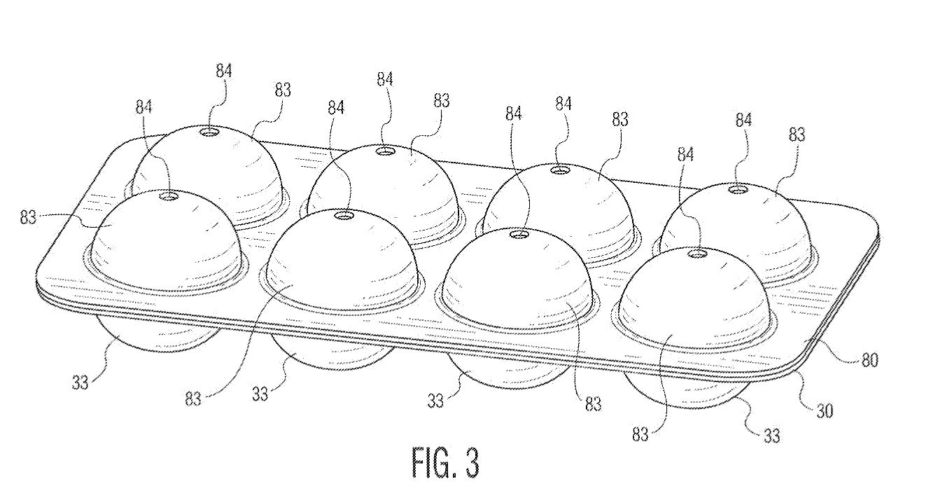

FIG. 3 illustrates an embodiment where the baking apparatus 100 includes eight molds 33, 83 formed in the first piece 30 and second piece 80, respectively, and in a 4×2 configuration, and with molds 83 also each having a hole 84 formed therein. The baking apparatus may be implemented with more or less molds or in a different configuration than shown in FIGS. 1-3.

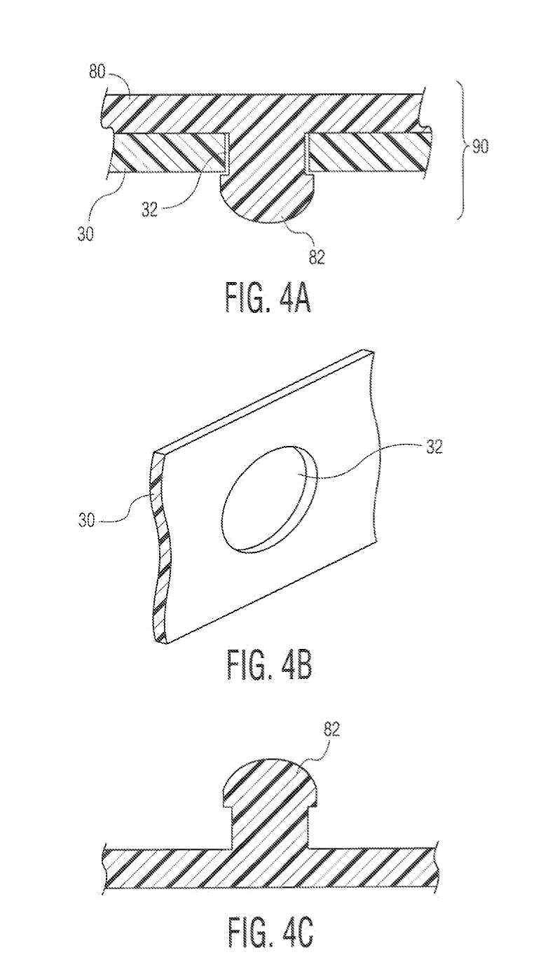

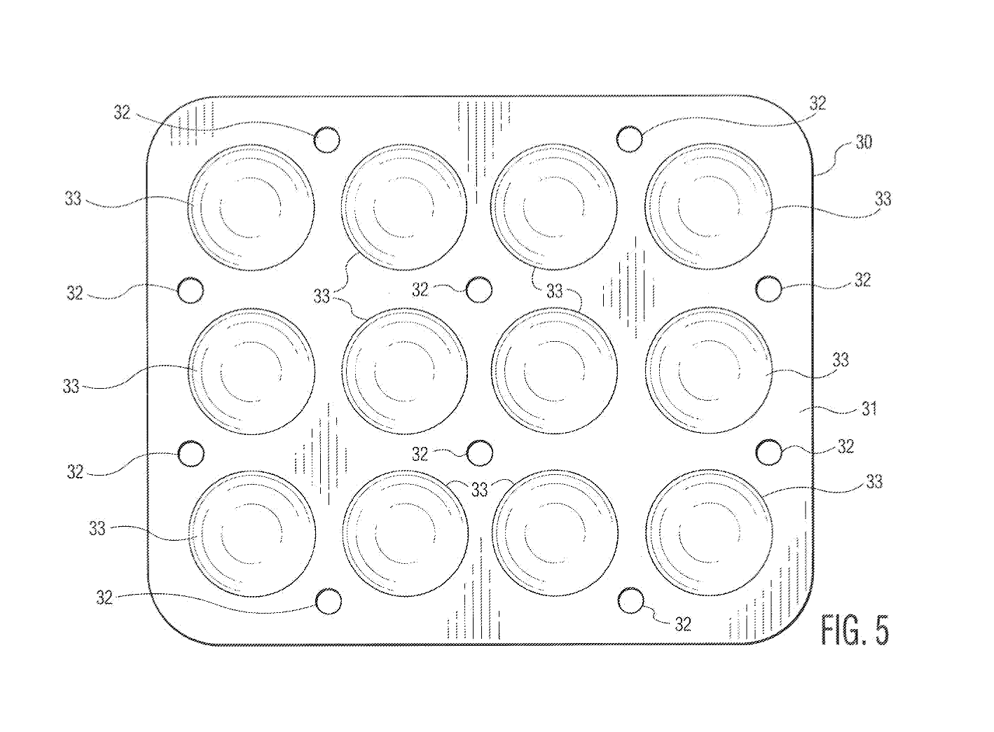

FIG. 4A illustrates the alignment mechanism 90 of the baking apparatus 100 of FIG. 1. The example alignment mechanism 90 of FIG. 4A comprises of an opening 32 into which is received a peg 82, which may include a button shaped top and has a circumference that is wider than the circumference of the opening 32, which may be formed in a first piece 30, as shown in FIG. 4A. FIG. 4B illustrates the opening 32 without the peg 82 engaged in the opening 32. FIG. 4C illustrates the peg 82 when it is not engaged in the opening 32.

FIG. 5 illustrates the first piece 30 of an embodiment of the baking apparatus 100 when viewed from the top of the first piece 30. The first piece 30 includes a surface 31 and at least one mold. 33 formed in the surface 30. The surface 31 may further include one or more openings 32 on the surface 31 of the first piece 30. The openings 32 may be positioned around the edge of the first piece 30, for example. In addition, openings 32 may also be placed near the center of the first piece 30, for example. The number of openings 32 may he more or less than the number shown in FIG. 3.

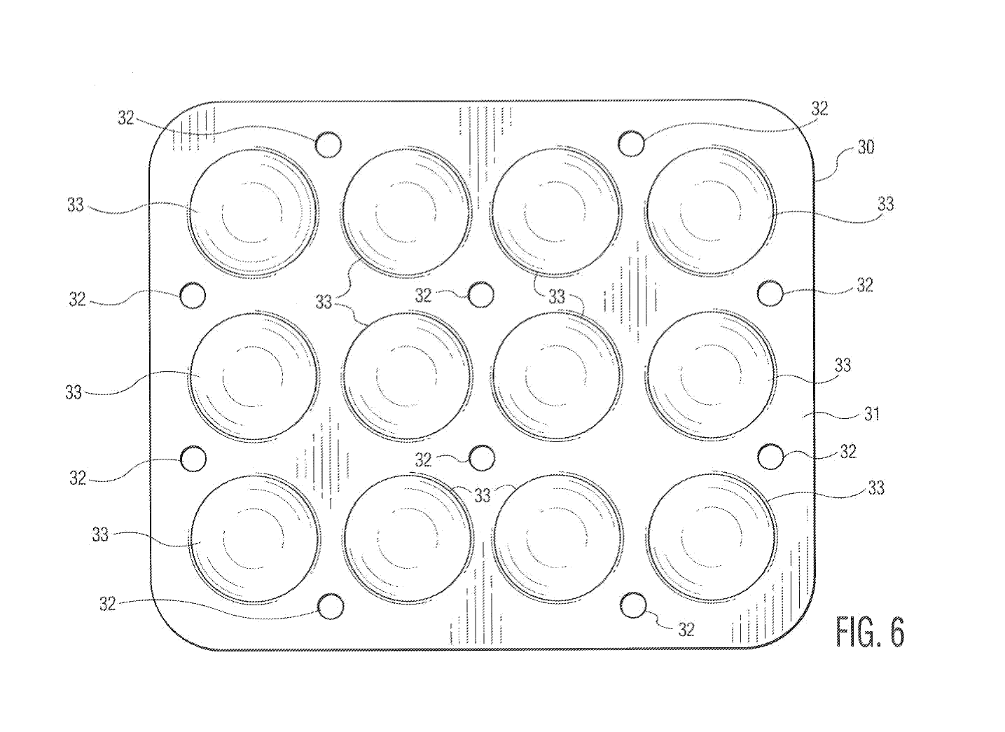

FIG. 6 illustrates the first piece 30 when viewed from the bottom. Molds 33 are formed in surface 31 of the first piece 30 of the baking apparatus 100. Further, openings 32 are formed in surface 31.

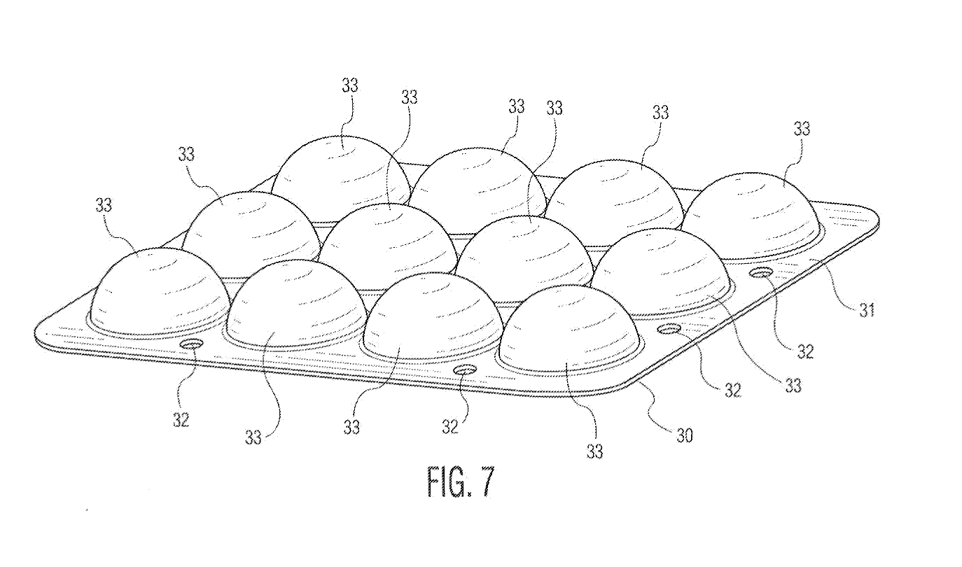

FIG. 7 illustrates the first piece 30 when viewed at an angle. Molds 33 may be formed in the surface 31 such that the molds 33 may hold a food product, for example. Openings 32 are also formed in surface 31 of the first piece 30.

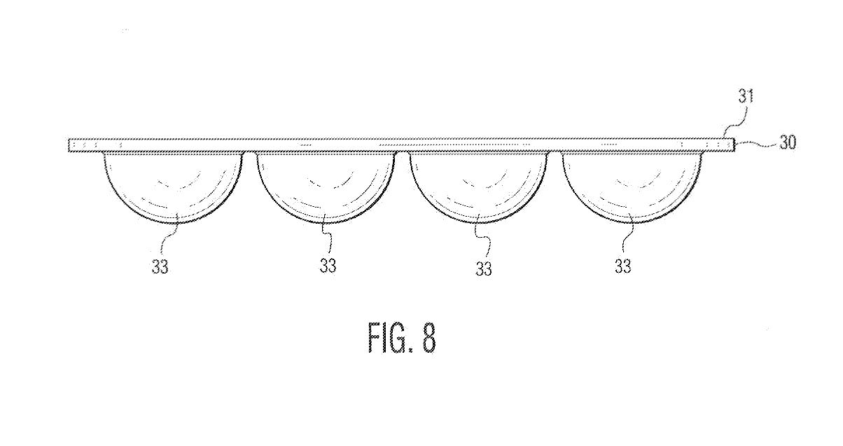

FIG. 8 illustrates a view from a first side of the first piece 30. Molds 33 visible from a first side of the first piece 30 are shown. Molds 31 are formed in the surface 31 of the first piece 30 so that the molds 33 may be filled with a food product, for example.

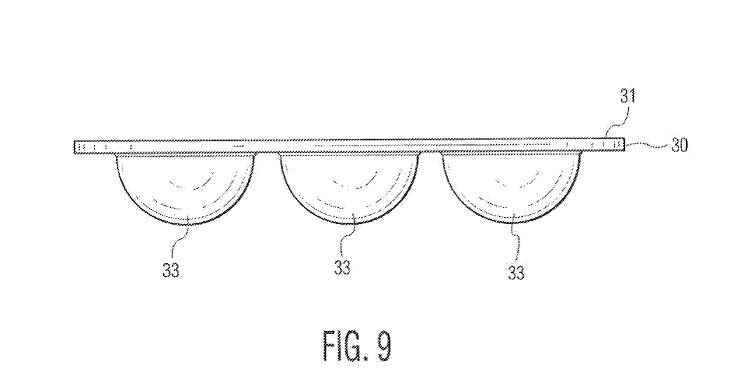

FIG. 9 illustrates a view from a second side of the first piece 30. Molds 33 visible from the second side are shown. These molds 33 are formed in the surface of the first piece 30.

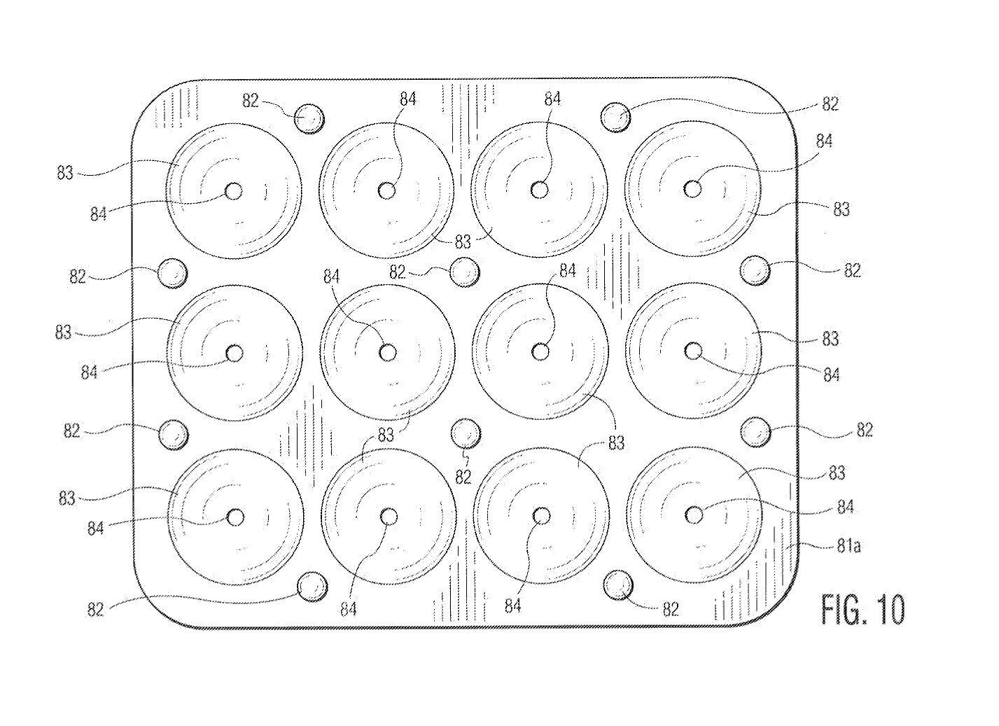

Referring to FIG. 10, FIG. 10 illustrates a top side of a surface 81a of the second piece 80 of the baking apparatus 100 which contains at least one mold 83 such that each mold 83 has a hole 84. The holes 84 facilitate the baking process and allow steam and excess food product to escape during, baking, for example. The holes 84 also allow for the baking process to be monitored, such as by allowing insertion of a toothpick, for example. The second piece 80 also contains at least one peg 82 which may be used to secure the second piece 80 to the first piece 30 to assemble the baking apparatus 100 as shown in FIGS. 1-3. The pegs 82 are also part of the alignment mechanism 90, which releasably attaches the first piece 30 to the second piece 80 to form the baking apparatus 100.

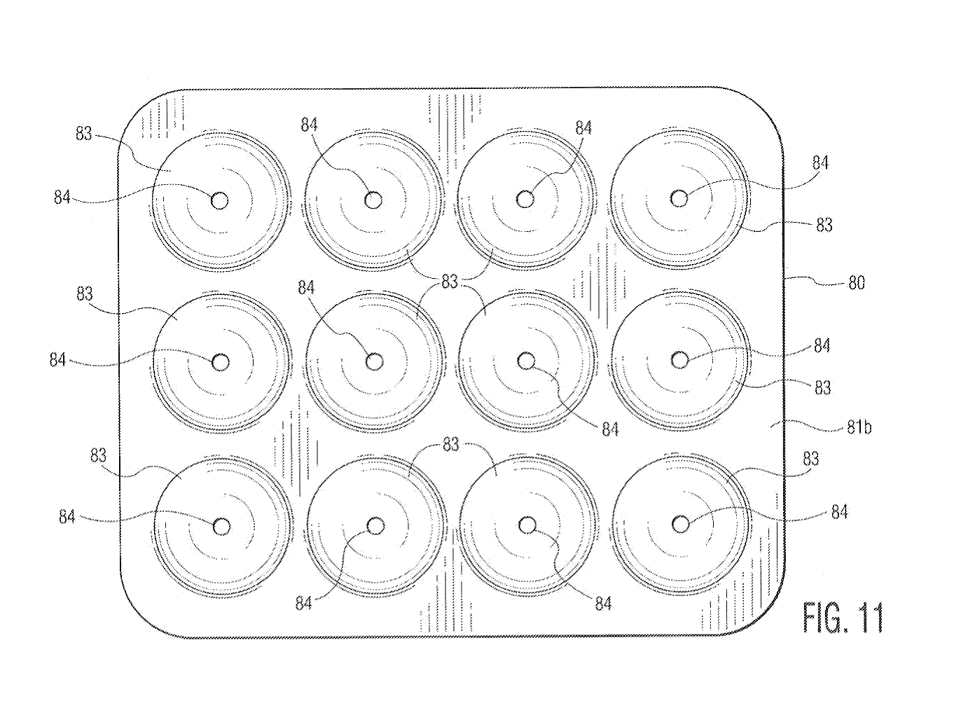

FIG. 11 illustrates a bottom side of surface 81b of second piece 80. Molds 83 are formed in surface 81 of the second piece 80. Holes 84 are also formed in molds 83.

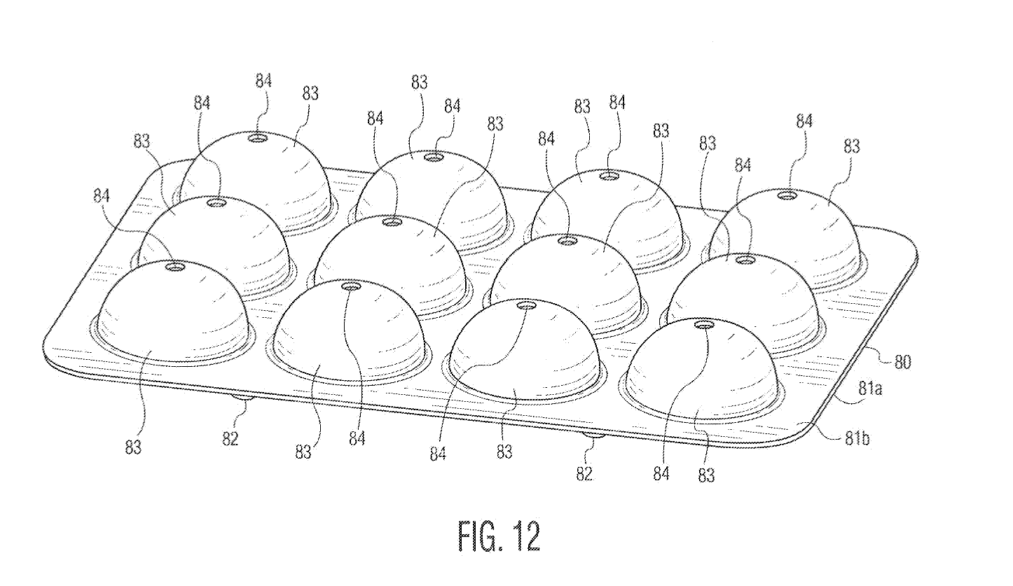

FIG. 12 illustrates the second piece 80 when viewed at an angle. Molds 83 may be formed in surface 81a,b such that molds 83 may he filled with a food product, for example. Holes 84 are also formed in molds 83. In addition, pegs 82 may be formed on one side of surface 81a.

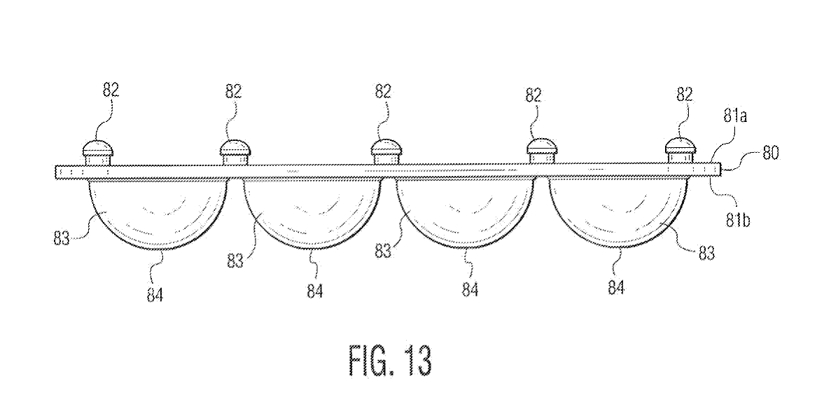

FIG. 13 illustrates a view from a first side of the second piece 80. Molds 83, each with holes 84, are formed in surface 81a,b of the second piece 80. Further the peg 82 portion of the alignment mechanism 90, as shown in FIG. 4A, is formed on the surface 81a of the second piece 80.

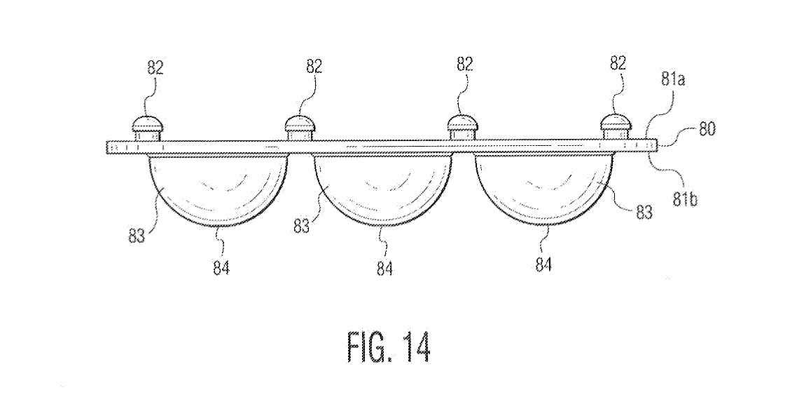

FIG. 14 illustrates a view from a second side of the second piece 80. Molds 83 are formed on surface 81a,b. Molds 83 include holes 84, for example. The second piece 80 also includes pegs 82 which are formed on surface 81a.

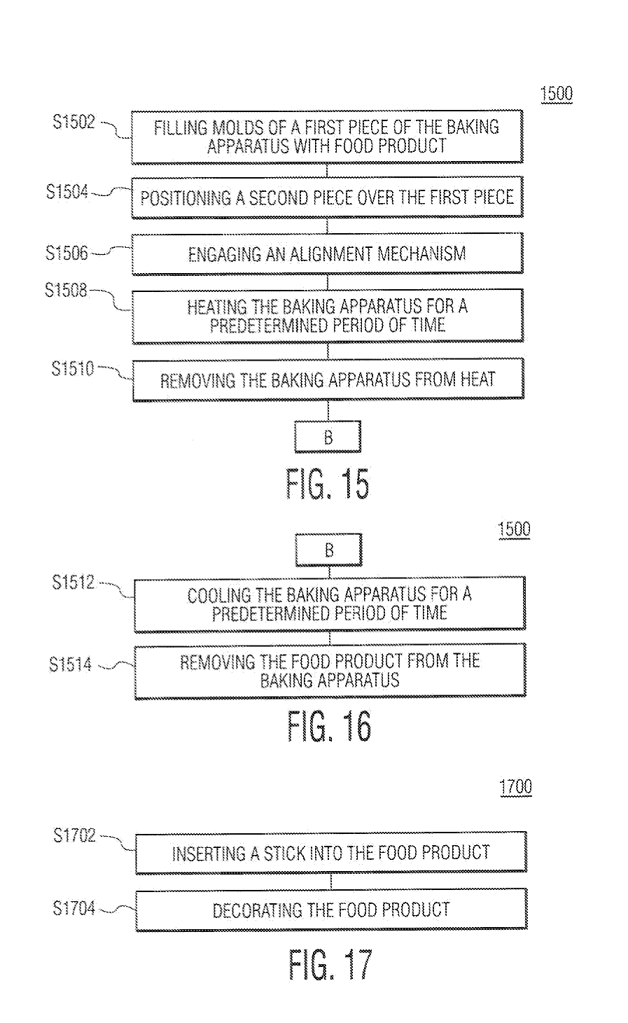

Referring to FIG. 15, a process 1500 for preparing a food product with a baking apparatus is illustrated. The molds 33 of a first piece 30 of the baking apparatus 100 are filled with a food product (S1502). The food product may include cake, brownie, or muffin batter, for example, or other suitable food products. Also, a lubricant, such as a non-stick cooking spray, may he applied to the molds 33 of the first piece 30 prior to filling the molds 33 with the food product. Further, the first piece 30 may, where desired, be placed on a sheet of metal or other surface, such as a baking sheet, for stabilization and increasing the ease of handling the first piece 30 and baking apparatus 100 during the process 1500 of preparing the food product.

The second piece 80 is positioned over the first piece 30 such that the molds 33 of the first piece 30 and molds 83 of the second piece 80 are in alignment (S1504). Further, the molds 33 and 83 may be positioned based on the alignment of the holes 32 of the first piece 30 and the pegs 82 of the second piece 80, where the holes 32 and pegs 82 form the alignment mechanism 90 as shown in FIG. 4A. The alignment mechanism 90 is engaged by inserting the pegs 82 of the second piece 80 into the corresponding openings 32 of the first piece 30 (S1506). FIGS. 1-3 illustrate the baking apparatus 100 when the alignment mechanism 90 of the first piece 30 and the second piece 80 are engaged.

The assembled baking apparatus 100 is then heated for a predetermined period of time to a desired temperature (S1508). In one illustration, the temperature of the baking apparatus should not exceed 450 degrees Fahrenheit, for example, although any other desired temperatures may also be utilized as appropriate. The predetermined time period may be the specified baking or heating time provided in the instructions of a cake, brown, or muffin mix, for example. The predetermined time period for heating may also be set by one skilled in the art.

Once the predetermined time lapses, the baking apparatus 100 may be removed from the heat source (S1510). The food product may be tested for doneness or solidification using a method used by one skilled in the art, such as inserting a toothpick to determine whether the food product should be heated further, for example.

Transitioning from B in FIG. 15 to the steps following B in FIG. 16, these additional steps may be performed in the process 1400 for preparing a food product using the baking apparatus 100. The process of preparing the food product with the baking apparatus 100 may further include, cooling the baking apparatus 100 for a predetermined period of time (S1512). This may include placing the baking apparatus 100 in an area that will allow for cooling for a predetermined period of time, for example. The baking apparatus 100 may also be left unattended for longer than the predetermined cooling time. In addition, the baking apparatus 100 may be placed in a refrigerator or freezer for further cooling, for example. Once the baking apparatus 100 has cooled, the food product may be removed from the baking apparatus 100 (S1514). This may include detaching the second piece 80 from the first piece 30, for example. Detaching the second piece 80 from the first piece 30 may comprise removing the pegs 82 of the second piece 80 from the openings 32 of the first piece 30. Once the second piece 80 is removed from the first piece 30, the food product may be removed from the molds 33 of the first piece 30. However, the food product may also he led in the molds 33 of the first piece 30 so that a stick may be inserted in the food product, for example. In addition, once the food product is removed from the first piece 30, the food product may be placed in the refrigerator for further cooling, if desired.

The process 1400 for preparing a food product may include further processing, such as decorating the food product. Referring to FIG. 17, the decorating process 1700 may include inserting a stick into the food product (S1702). The stick may be of any desired shape or material, for instance, a conventional lollipop stick. In one example, the stick is placed half way through the length of the food product, but may be inserted at other desired amounts. The stick may also be placed in a sauce, which is viscous, such as icing or a chocolate sauce product, such as a melted chocolate sauce, prior to insertion in the food product.

Once the stick has been inserted into the food product, the food product may be decorated in any desired manner (S1704). For example, the food product may be dipped in a desired sauce, and which may also be dipped in decorative food items, such as sprinkles, nuts, or appropriate chocolate chips, as may be desired, or any other suitable items. Further, the food product may be dipped in the sauce using the inserted stick, for example. As should be understood, the food product may also be decorated prior to or without use of a stick, where desired.

Although the apparatus and methods have been described in connection with specific forms thereof, it will be appreciated that a wide variety of equivalents may be substituted for the specified elements described herein without departing from the spirit and scope of this disclosure as described in the appended claims.

What is claimed is:

1. A method for preparing a food product with a baking apparatus, comprising:
filling a plurality of molds of a first piece of the baking apparatus with the food product;
positioning a second piece of the baking apparatus over the first piece, the second piece comprises a plurality molds each comprising a hole;
engaging an alignment mechanism of the first piece and the second piece;
heating the baking apparatus for a predetermined period of time; and
removing the baking apparatus from heat.

2. The method of claim 1, wherein engaging an alignment mechanism comprises:
aligning a plurality of openings on a surface of first piece with a plurality of pegs on a surface of the second piece; and
securing the plurality of pegs in the plurality of holes.

3. The method of claim 1, further comprising:
detaching the second piece from the first piece; and
removing the food product from the first piece.

4. A method for preparing a food product with a baking apparatus, comprising:
filling a plurality of molds of a first piece of the baking apparatus with the food product;
positioning a second piece of the baking apparatus over the first piece, the second piece comprises a plurality of molds corresponding to the plurality of molds of the first piece;
engaging an alignment mechanism such that the plurality of molds of the first and second pieces are in alignment;
heating the baking apparatus for a predetermined period of time at a predetermined temperature;
cooling the baking apparatus; and
removing the food product from the baking apparatus.

5. The method of claim 4, wherein cooling the baking apparatus comprises:
removing the baking apparatus from heat for a predetermined period of time.

6. method of claim 5, wherein cooling the baking apparatus further comprises:
placing the food product in a cooling apparatus for a predetermined period of time.

7. The method of claim 4, further comprising:
inserting a stick in the food product; and
decorating the food product.

8. The method of claim 7, wherein decorating the food product comprises:
dipping at least a portion of the food product in a sauce; and
placing at least one of an icing and a decoration on the dipped food product.

9. The method of claim 8, wherein the sauce is viscous.
